(19) United States
(12) Patent Application Publication
(10) Pub. No.: US 2003/0128235 A1
(43) Pub. Date: Jul. 10, 2003

(54) System for associating graphics frames with events and method therefor

(75) Inventors: Robert L. Chernow, Cedar Park, TX (US); Rebecca Lynn Roberts, Austin, TX (US); Leland James Wiesehuegel, Austin, TX (US); Gregory Alan Jones, Austin, TX (US)

Correspondence Address: Barry S. Newberger, 5400 Renaissance Tower, 1201 Elm Street, Dallas, TX, 75270, US

(73) Assignee: International Business Machines Corporation, Armonk, NY

(21) Appl. No.: 10/045,259

(22) Filed: Jan. 10, 2002

(51) Int. Cl. G09G 5/00

(52) U.S. Cl. 345/744

(57) ABSTRACT

Systems and methods for associating graphical images and events are implemented. These include, respectively, circuitry and steps for providing graphical image information including control information and rendering information in which the control information is for controlling a display of said rendering information. The control information includes an image identifier. An event identifier value is received in response to a client initiated action. The rendering information is displayed in response to said event identifier value matching a value of said image identifier in said control information. An alternative system and method include, respectively, circuitry and steps for receiving a value for an event parameter associated with a graphical image file. In response to receiving an event corresponding to said event parameter, rendering information for a graphical image in said graphical image file corresponding to the value of said event parameter is displayed. The rendering information may include differential image information.

### TECHNICAL FIELD

The present invention relates in general to data processing systems, and in particular, to data processing and methods for associating graphical images displayed on a Web page with client side events.

### BACKGROUND INFORMATION

The development of computerized distribution information systems, such as the Internet, allows users to link with servers and networks, and thus retrieve vast amounts of electronic information that was previously not readily available or unavailable using conventional electronic media.

Users may be linked to the Internet through a hypertext based service commonly referred to as the World Wide Web (WWW, or simply, Web). (The WWW may also be used in a broader sense to refer to the whole constellation of resources that can be accessed using one or more of the protocols that embody the TCP/IP suite, described further below.) With the World Wide Web, an entity may register a domain name correlated with an electronic address (referred to an IP address) representing a logical node on the Internet and may create a “Web page” or “page” that can provide information and some degree of interactivity.

The Internet is based upon a suite of communication protocols known as Transmission Control Protocol/Internet Protocol (TCP/IP) which sends packets of data between a host machine, such as a server computer on the Internet commonly referred to as Web server, and a client machine, such as user's computer connected to the Internet. The WWW communications may typically use the Hypertext Transfer Protocol (HTTP) which is supported by the TCP/IP transmission protocols, however, file transfer and other services via the WWW may use other communication protocols, for example the File Transfer Protocol (FTP).

A computer user may “browse”, i.e., navigate around, the WWW by utilizing a suitable Web browser, e.g., an Netscape™, Internet Explorer™, iCab™ and a network gateway, e.g., an internet service provider (ISP). A Web browser allows the user to specify or search for a Web page on the WWW and subsequently retrieve and display Web pages on the user's computer screen. Such Web browsers are typically installed on personal computers or workstations to provide Web client services, but increasingly may be found on other wired devices, for example personal digital assistants (PDA) or wireless devices such as cell phones.

A Web page may typically include presentation components, e.g., navigational menus, popup windows/menus, charts, graphs, of visual images (static and dynamic), video and/or text. Static images, video and/or text may be specified in various languages or protocols such as Hyper-Text Mark-up Language (HTML), Extensible Hyper-Text Mark-up Language (XHTML), Dynamic Hyper-Text Mark-up Language (DHTML), JavaScript, Cascading Style Sheets (CSS), Scalable Vector Graphics (SVG), Document Object Model (DOM), Extensible Stylesheet Language (XSL), Extensible Mark-up Language (XML) and Synchronized Multimedia Integration Language (SMIL).

For example, images, video and/or text may be specified in a HTML file that is sent from the Web server to the client machine. (Web client is typically used to refer to the software on a data processing system that receives and processes Web pages to render them perceivable by a human user of the system. For simplicity of nomenclature, Web client will be used herein to interchangeably refer to the software and the human user of the system on which the client software is deployed.) The HTML file may then be parsed by the Web browser in order to display the text and images on the display of the client machine.

Users may navigate through a Web page or between linked Web pages by selecting links embedded in the page. In addition to the familiar text-based link, these may also be presented to the user in the form of a “button,” tab or similar device graphically displayed on the users display. Selection may be effected, then, by positioning a user input device, for example, a “mouse” cursor over the desired button or tab and “clicking” on the button, tab or similar image. Typically, the page selected thereby, displays the same button or tab image, often with a different background color or different label color to indicate that the Web page displayed corresponds to the particular button, tab or similar control. For example, illustrated in FIG. 1, is a graphic of a “button” which may be displayed in a Web page to link to a second page with data related to “payment forecasts”. Image 102 may represent a button prior to selection by the user. Image 104 with “inverted” pixels or similar highlighted text and alternate background, may denote a selected button or other control and corresponding displayed page. In this instance, the Web page must store two separate images for the control, one to display it in the initial state and one to display it with the different color or shading scheme upon the selection of the control. As a consequence, a multiplicity of graphics files for imaging the controls on the Web page are required which may exacerbate storage requirements on the server, as well as increasing the effort expended in generating the images. Both may be further increased in an international environment in which the provider of the Web pages reproduces the content in a multiplicity of languages. Consequently, there is a need in the art for systems and method for displaying graphical images associated with controls and Web pages having reduced storage requirements, and which additionally reduce the demands placed on other resources associated with the development of the Web pages.

### SUMMARY OF THE INVENTION

The aforementioned needs are addressed by the present invention. Accordingly there are provided systems and methods for associating graphical images with events that include, respectively circuitry and steps for providing graphical image information including control information and rendering information in which the control information is for controlling a display of said rendering information. The control information includes an image identifier. An event identifier value is received in response to a client-initiated action. The rendering information is displayed in response to said event identifier value matching a value of said image identifier in said control information.

Additionally there are provided alternative systems and methods for associating graphical images with events. These include, respectively, circuitry and steps for receiving a value for an event parameter associated with a graphical image file. In response to receiving an event corresponding to said event parameter, rendering information for a graphical image in the graphical image file corresponding to said value of said event parameter is displayed. The rendering information may include differential image information.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates exemplary graphical images which may be associated with a control in a Web page which may be used in conjunction with the present invention;

FIG. 2 illustrates, in block diagram form, a data processing system in accordance with an embodiment of the present invention;

FIG. 3 illustrates, in flowchart form, a methodology in accordance with an embodiment of the present invention;

FIGS. 4.1 and 4.2 schematically illustrate a portion of a data structure for containing graphical image data and associated control information;

FIG. 5 illustrates, in flowchart form, a methodology in accordance with an alternative embodiment of the present invention;

FIG. 6 illustrates, in flowchart form, a methodology in accordance with another embodiment of the present invention; and

FIG. 7 illustrates, a portion of the methodology of FIG. 6 in further detail.

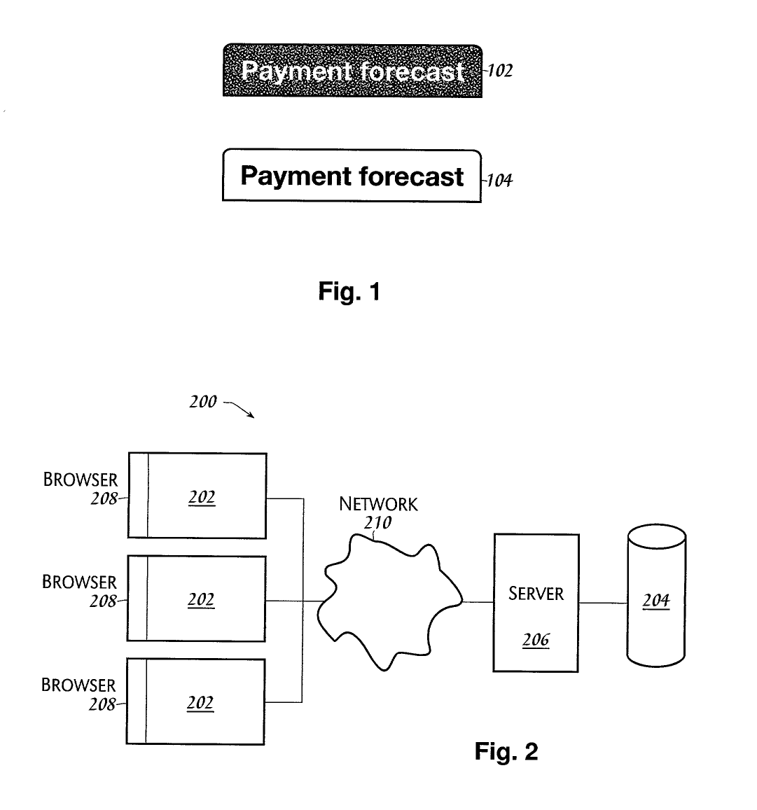

### DETAILED DESCRIPTION

In the following description, numerous specific details are set forth to provide a thorough understanding of the present invention. For example, data structures, or fields therein, may be described in conjunction with a particular number of bits, however, it will be recognized by those of ordinary skill in the art that the present invention may be practiced without such specific details. In other instances, well-known circuits have been shown in block diagram form in order not to obscure the present invention in unnecessary detail.

Refer now to the drawings wherein depicted elements are not necessarily shown to scale and wherein like or similar elements are designated by the same reference numeral through the several views.

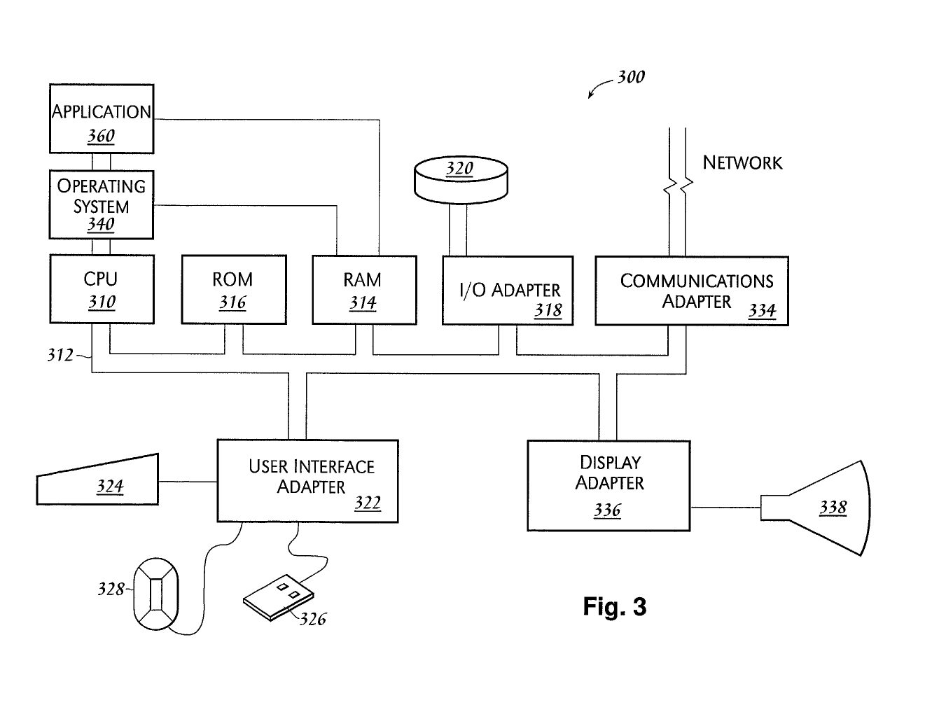

Referring to FIG. 2, there is illustrated a Web client-server system 200, in accordance with the principles of the present invention. System 200 includes one or more clients 202. Access to Web document data 204 is mediated via server 206. Clients 202 may be coupled to server 206 via network 210, which may be a local area network (LAN), wide area network (WAN), or the Internet. Clients 202 may include a Web browser 208 for requesting Web documents, which may also be referred to as Web pages, from server 206 and rendering the requested Web pages as previously described. Web browser 208 may incorporate mechanisms for rendering graphical images representing controls contained in the Web pages in accordance with the present inventive principles described in further detail in conjunction with FIGS. 3-7 hereinbelow.

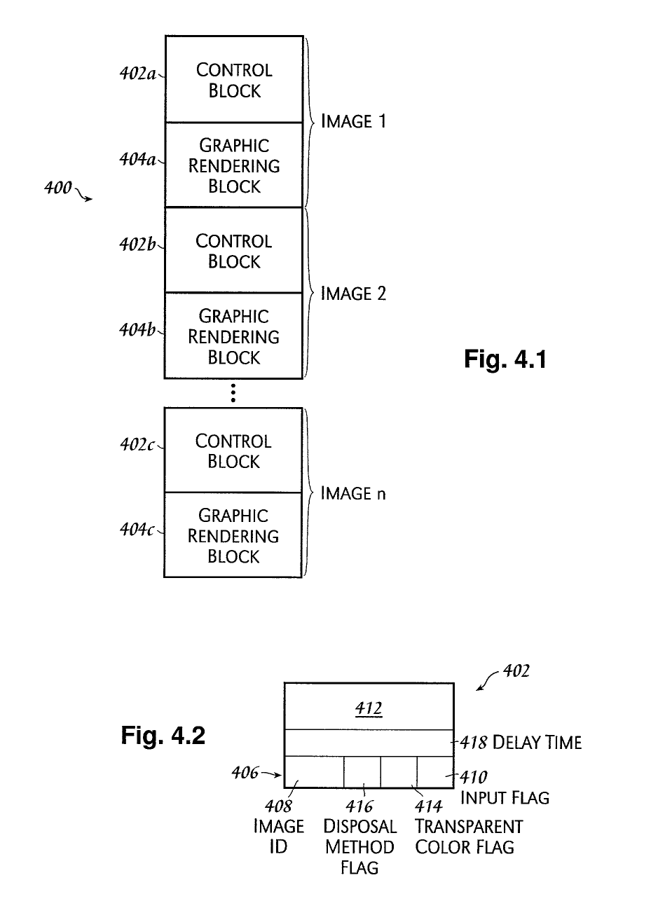

Refer now to FIG. 3 which illustrates a data processing system 300 in accordance with the principles of the present invention. System 300 may be used in an embodiment of client(s) 202. System 300 has a central processing unit (CPU) 310, such as a conventional microprocessor, coupled to various other components by system bus 312. An operating system 340 runs on CPU 310 and provides control and coordinates the function of the various components of system 300. Application 360 includes instructions for rendering graphical images representing controls in a Web page in accordance with the principles of the present invention, and which will be described further in conjunction further with FIGS. 4.1-7 hereinbelow. Application 360 runs in conjunction with operating system 340, which coordinates the internal functions of system 300, and may provide services to application 360 as would be understood by those of ordinary skill in the art. Read-only memory (ROM) 316 is coupled to system bus 312 and includes a basic input/output system (“BIOS”) that controls certain basic functions of system 300. Random access memory (RAM) 314, I/O adapter 318, and communications adapter 334 are also coupled to system bus 312. It should be noted that software components including operating system 340 and application 360 are loaded into RAM 314 which is the computer system's main memory. I/O adapter 318 may be a peripheral component interface (“PCI”) adapter that communicates with disk units 320. Communications adapter 334 interconnects bus 312 with an Intranet or Internet enabling client 202 to communicate with a server, such as server 206, FIG. 2. Input/Output devices may also be connected to system bus 312 via a user interface adapter 322 and a display adapter 336. Keyboard 324, trackball 328, and mouse 326 are all interconnected to bus 312 through user interface adapter 322. Event actions may be input to client 202, through any of these devices.

Implementations of the invention include implementations as a computer system programmed to execute the method or methods described herein, and as a computer program product. According to the computer system implementation, sets of instructions for executing the method or methods are resident in the random access memory 314 of one or more computer systems configured generally as described above. Until required by the computer system, the set of instructions may be stored as a computer program product in another computer memory, for example, in disk drive 320 (which may include a removable memory such as an optical disk or floppy disk for eventual use in the disk drive 320). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

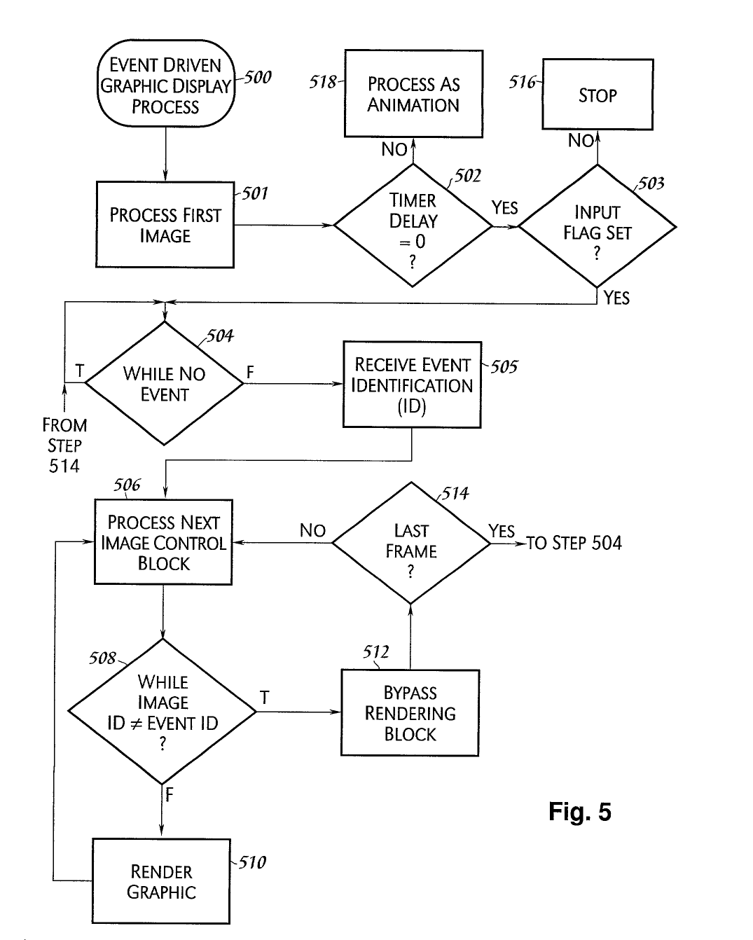

Refer now to FIG. 4.1 schematically illustrating a portion 400 of a graphics file which may be used in accordance with the principles of the present invention. FIG. 4.2 will illustrate portions of FIG. 4.1 in additional detail. (A methodology for processing graphics files including images formatted in accordance with portion 400 will be described in conjunction with FIGS. 5-7.) Portion 400 includes a plurality of control blocks 402a-402c and a plurality of graphic rendering blocks 404a-404c. (Note that the control blocks may be referred to individually as a control block 402, or collectively as control blocks 402 and similarly, a graphic rendering block may be referred to singularly as a graphic rendering block 404 or collectively as graphic rendering blocks 404, as the context requires. Graphic control blocks and graphics rendering blocks may also be referred to, simply, as control blocks and rendering blocks, respectively.) A graphic control block 402 is associated with a graphic rendering block 404, and contains control information for the rendering of the graphic information contained in the associated graphic rendering block 404. Each control block 402 and its associated graphic rendering block may represent an image in the graphics file. In the illustrative embodiment in FIG. 4.1, there are n images corresponding to the graphic control block and graphic rendering block pairs (402a, 404a) representing image 1, (402b, 404b) representing image 2 and (402c, 404c) representing image n. Note that the structure of portion 400 may be similar to the Graphics Interchange Format™ (GIF). (The Graphics Interchange Format is defined in specification, GIF 89a, Copyright 1990, CompuServe, Inc., Columbus, Ohio, which is hereby incorporated herein by reference in its entirety.) Graphic rendering blocks 404 may include, in accordance with the GIF specification a logical screen descriptor, an image descriptor and, optionally, a global color table and a local color table. These contain information and data to render the corresponding graphic on a display device, such as display device 338, FIG. 3. Image data included in a graphic rendering block 404 may be compressed. For example, data encapsulated in accordance with the GIF specification may be compressed using the Lempel-Ziv-Welch (LZW) algorithm, as disclosed in U.S. Pat. No. 4,558,302 of Welch. As previously noted, control blocks 402 include data for controlling the rendering of the corresponding graphical data in the associated graphic rendering block 404.

Referring now to FIG. 4.2, a control block in accordance with the present inventive principles is illustrated in additional detail. Control block 402 includes a field 406 having an image identifier (ID) portion 408 and an input flag portion 410. In addition, control block 402 may include field portion 412, which may include a plurality of fields, having a structure in accordance with the GIF specification for a graphic control extension. Additionally, a control block 402 may include a transparent color flag 414, a disposal method flag 416 and a delay time 418, also in accordance with the GIF specification. Transparent color flag 414, and disposal method flag 416 may also be included in field 406, as depicted in FIG. 4.2.

Refer now to FIG. 5, illustrating event driven graphic display process 500 in accordance with the principles of the present invention. Process 500 may be used with an embodiment of graphical image data in accordance with the format described hereinabove in conjunction with FIGS. 4.1 and 4.2. Note that, as used herein and described further below a graphical image may constitute a portion of a composite image. In step 501, a first graphical image is processed. In processing the graphical image in step 501, control and image data may be read from the associated control block and rendering block, respectively, and the image data in the rendering block decoded to generate graphic data which may be rendered on a display device, such as display 338, FIG. 3. The graphical data may be rendered on the display in response to control data in the corresponding control block. Note that control data may include an input flag such as input flag 410, FIG. 4.2. As previously described, a control block may include field containing a delay time value. If, in step 502, the delay time value is not zero, the graphics file is processed as an animation, step 518. Otherwise, in step 503 it is determined of the input flag, such as input flag 410, FIG. 4.2, is set. If, in step 503, the input flag is set, process 500 proceeds to step 504, to process graphical control images in association with events. Otherwise, if the input flag is reset, that is negated (in its logically false state), then, in step 518, the graphics file is processed as an animation using delay time information, as described, for example, in GIF 89a.

In step 504, process 500 enters an event loop. Events may include “mouse clicks,” the movement of a cursor over a particular region in the displayed document or Web page (“mouseovers”), keyboard entries, etc. In response to a received event, step 504 breaks out of the event loop. The event may be passed to process 500 via an event handler associated with the particular event. The capture of events and associating event handlers with a particular event may depend on the particular programming language from which the Web page has been developed. For example, JavaScript provides techniques for associating controls, such as, buttons, displayed on a Web page with an event handler which provides a set of JavaScript statements which are executed when the button, or similar control is activated by a mouse click on the control, or other such user initiated action. The statements associated with an event handler in an embodiment in accordance with JavaScript, may be included in a JavaScript function.

On the receipt of an event targeted to process 500 as defined by the event handler, step 504 breaks out of the loop. In step 505, an event identifier (ID) is received. The event ID may be a value passed to process 500 by the event handler. In step 506, the next image control block in sequence in the graphical image is processed. Steps 506, 508 and 510 form a loop over graphical images that may be applied to the images already displayed, in particular to the image displayed in step 501. While, in step 508, the image ID, for example the value in image ID field 408 in an embodiment of an image control block in accordance with FIG. 4.2 described hereinabove, corresponds to the event ID value received in step 505, the corresponding the corresponding graphic rendering block is decoded and the graphic rendered on the display device, step 510. Process 500 then returns to step 506 to close the aforementioned loop. Note that the graphical data in the blocks rendered in step 510 may constitute only such data as is necessary to update the first image, already displayed on the screen. In other words, the graphical data may include differential information between the first image and the updated image whereby the updated image is formed as a composite. Additionally, in an embodiment in accordance with the GIF Specification, the differential data may be aggregated to form the composite by setting the value in disposal method flag 416, FIG. 4.2 corresponding to “do not dispose,” which value may be 1. In this way, a button or similar control background may be inverted, for example, to depict that the button or similar control has been selected, without having to store and retrieve a separate image file to display the selected control. The image data is decoded and rendered in the same fashion as the processing of the first image in the file, discussed hereinabove in conjunction with step 502.

Returning to step 508, while the image ID does not correspond to the event ID value, the corresponding rendering block is bypassed, step 512. If the current frame is not a last frame, step 514, process 500 returns to step 506 to continue processing frames. If however, the current frame is the last frame, process 500 returns to step 504 to handle further events.

Returning to step 508, if the input flag is set, and the image ID does not correspond to the event ID, in step 512, the graphics rendering block corresponding to the current image control block is bypassed. In step 514, if the file contains additional frames, process 500 continues to loop through steps 506-512 to test each control block in sequence. Otherwise, process 500 terminates in step 516 with the last frame in the file.

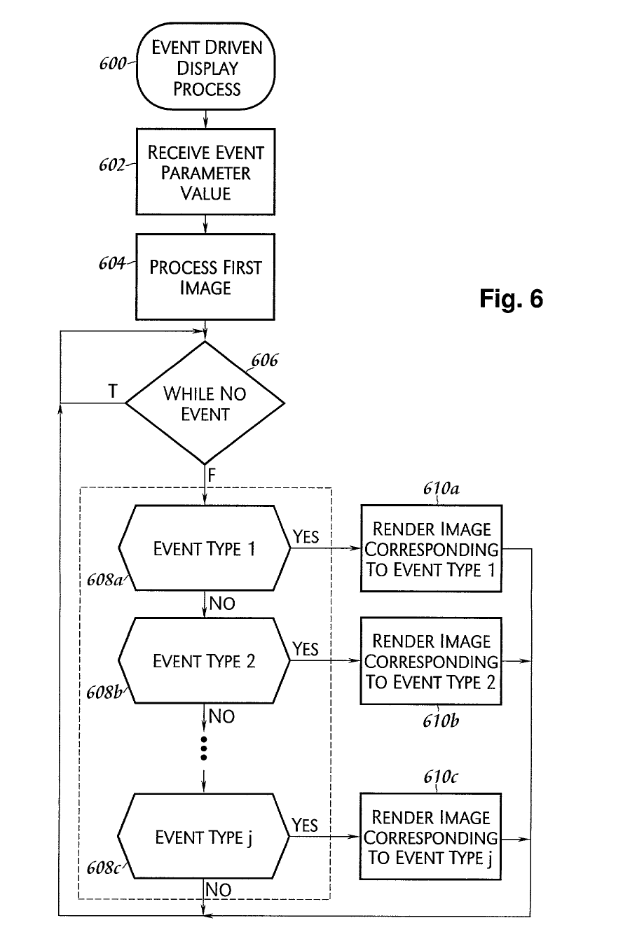

Refer now to FIG. 6 illustrating an alternative embodiment, event driven graphic display process 600 in accordance with the principles of the present invention. In step 602, an event parameter value is received from the Web page. An event parameter may be associated with the Web page coding that inserts the graphical image for the control into the page. For example, an image (IMG) tag, in HTML, or a similar tag in XML, may be used to specify an image to be displayed in the document. By incorporating event parameters into the IMG tag specification, an image in a graphical image file may be associated with a value of the event parameter, for example “a mouse” or “mouseover” event, in accordance with the principles of the present invention. Additionally, in an extensible markup language, such as XML, the parameters may be included in a new tag definition. The value of the event parameter may be passed to process 600 by the event handler associated with the event type, for example, the “mouse click” event handler if the event type is a “mouse click,” and similarly for other event types.

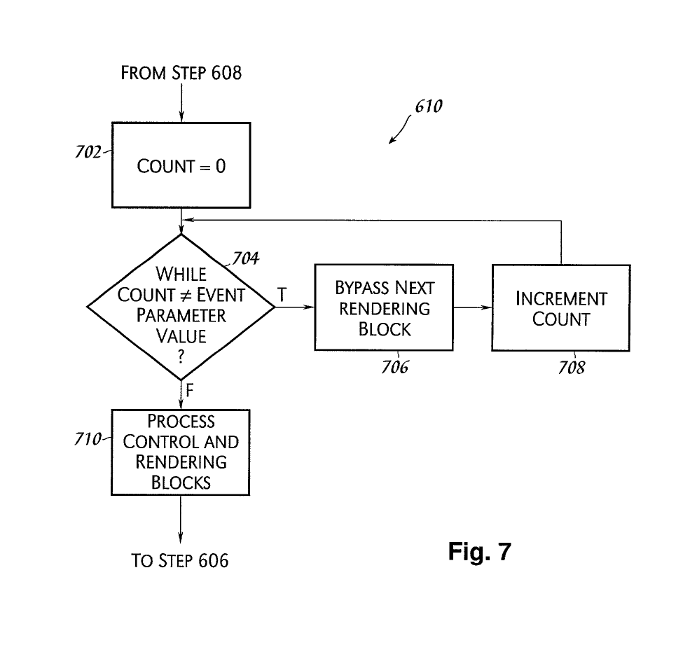

In step 604, the first image in the graphics file associated with the image tag in the document is processed. The processing of the first image may be performed as previously discussed hereinabove in conjunction with FIG. 5. In step 606, process 600 enters an event loop. On the receipt of an event by process 600, which may be received via an event handler as previously described hereinabove, step 606 breaks out of the loop. Process 600 then proceeds to j-way decision block, step 608. In general, in multiplicity, j, of events may be associated with images in a graphical image file. (For example, in JavaScript, step 608 may be implemented via a switch statement. The C programming language has a similar syntactical construct.) If the event type is an event of type 1, say by way of example, a “mouse click,” then in substep 608a, process 600 proceeds by the “Yes” branch and in step 610a the image corresponding to event type 1, as determined by the value of the type 1 event parameter retrieved in step 602, is rendered. (A methodology for rendering images corresponding to the ith event type will be described in conjunction with FIG. 7, below.) Otherwise substep 608a proceeds, via the “No” branch to substep 608b. If the event type passed by the corresponding event handler is an event of type 2, say by way of example, a “mouseover,” then in step 612 the corresponding image, as determined by the value associated with the type 2 event parameter is rendered. Similarly, in substep 608c, if the event type is an event of type j, then the corresponding image is rendered in step 614. Process 600 then returns to step 606 to process further events. In this way, a graphical image associated with a control may be rendered with inverted pixels, or similar depiction to indicate that the control has been selected.

Refer now to FIG. 7 in which is depicted, in flowchart form, an embodiment of step 610 for rendering an imaging of graphics image file associated with an event parameter. The embodiment illustrated in FIG. 7 may be used in conjunction with a graphics image file as described in conjunction with FIGS. 4.1 and 4.2 hereinabove. In step 702, a counter is initialized, the initial value of which may be zero. In step 704, a loop is entered in which while the count value remains unequal to the event parameter value, as received, (for example, in step 602, FIG. 6), the process sequentially bypasses rendering blocks in the graphical image file, via step 706. Additionally, in step 708, the counter is incremented, as each rendering block is bypassed. (Note, that any corresponding control block is also bypassed.)

If, however, in step 704, the counter value is equal to the event parameter value, step 704 breaks out of the loop via the “false” path, and in step 710, the current control and associated graphics rendering block are processed, thereby rendering the graphic image data contained in the rendering block on the display device, as previously described hereinabove. Step 610 then returns to step 606 as previously discussed.

Although the present invention and its advantages have been described in detail, it should be understood that various changes, substitutions and alterations can be made herein without departing from the spirit and scope of the invention as defined by the appended claims.

What is claimed is:

1. A method comprising the steps of:
receiving graphical image information including control information and rendering information, said control information for controlling a display of said rendering information, wherein said control information comprises an image identifier value;
receiving an event identifier value in response to a client initiated action; and
displaying said rendering information in response to said event identifier value matching said image identifier value in said control information, wherein said rendering information represents at least one image comprising differential image information for generating a composite image

2. The method of claim 1 wherein said graphical image information includes control information and corresponding rendering information representing a plurality of graphical images and wherein said method further comprises initially displaying a first graphical image of said plurality of graphical images.

3. The method of claim 2 wherein said rendering information in said displaying step comprises rendering information representing a second graphical image of said plurality of graphical images and wherein said first and second graphical images generate said composite image.

4. The method of claim 3 wherein said first and second graphical images respectively represent first and second states of a control element in one or more web pages.

5. A method comprising:
receiving a value for an event parameter associated with a graphical image file;
receiving an event corresponding to said event parameter; and
displaying rendering information for a graphical image in said graphical image file corresponding to said value of said event parameter in response to said event in said receiving step and wherein said rendering information comprises differential image information, wherein said graphical image file comprises a plurality of graphical images and wherein said method further comprises initially displaying a first graphical image of said plurality of graphical images, said displaying step comprising displaying rendering information representing a second graphical image of said plurality of graphical images said first and second graphical images generating a composite image.

6. The method of claim 5 wherein said event in said receiving step is received from an event handler for a type of said event.

7. The method of claim 5 wherein said step of displaying rendering information comprises the steps of:
sequentially bypassing a set of graphical images in said plurality of graphical images while a count value does not equal said event parameter value; and
if said count value equals said event parameter value, displaying rendering information of a current graphical image in sequence in said plurality of graphical images.

8. The method of claim 7 further comprising the steps of:
initializing said count value; and
incrementing said count value for each sequential bypass of said set of graphical images.

9. A computer program product embodied in a machine readable medium for associating graphical images displayed on a web page with client side events comprising the programming steps of:
receiving graphical image information including control information and rendering information, said control information for controlling a display of said rendering information, wherein said control information comprises an image identifier value;
receiving an event identifier value in response to a client initiated action; and
displaying said rendering information in response to said event identifier value matching said image identifier value in said control information, wherein said rendering information represents at least one graphical image comprising differential image information for generating a composite image.

10. The computer program product as recited claim 9, wherein said graphical image information includes control information and corresponding rendering information representing a plurality of graphical images, wherein the computer program product further comprises the programming step of:
initially displaying a first graphical image of said plurality of graphical images.

11. The computer program product of claim 10, wherein said rendering information in said displaying programming step comprises rendering information representing a second graphical image of said plurality of graphical images and wherein said first and second graphical images generating a composite image.

12. The computer program product of claim 9, wherein said first and second graphical images respectively represent first and second states of a control element in one or more web pages.

13. A computer program product embodied in a machine readable medium for associating graphical images displayed on a web page with client side events comprising the programming steps of:
receiving a value for an event parameter associated with a graphical image file;
receiving an event corresponding to said event parameter; and
displaying rendering information for a graphical image in said graphical image file corresponding to said value of said event parameter in response to said event in said receiving step and wherein said rendering information comprises differential image information, wherein said graphical image file comprises a plurality of graphical images, wherein the computer program product further comprises the programming step of:
initially displaying a first graphical image of said plurality of graphical images, wherein said displaying programming step comprises displaying rendering information representing a second graphical image of said plurality of graphical images said first and second graphical images generating a composite image.

14. The computer program product as recited in claim 13, wherein said event in said receiving programming step is received from an event handler for a type of said event.

15. The computer program product as recited in claim 13, wherein said graphical image file comprises a plurality of graphical images, wherein said programming step of displaying rendering information comprises the programming steps of:
sequentially bypassing a set of graphical images in said plurality of graphical images while a count value does not equal said event parameter value; and
if said count value equals said event parameter value, displaying rendering information of a current graphical image in sequence in said plurality of graphical images.

16. The computer program product as recited in claim 15 further comprises the programming steps of:
initializing said count value; and
incrementing said count value for each sequential bypass of said set of graphical images.

17. A system, comprising:
a memory unit operable for storing a computer program operable for associating graphical images displayed on a web page with client side events; and
a processor coupled to said memory unit, wherein said processor, responsive to said computer program, comprises:
circuitry operable for providing graphical image information including control information and rendering information, said control information for controlling a display of said rendering information, wherein said control information comprises an image identifier value;
circuitry operable for receiving an event identifier value in response to a client initiated action; and
circuitry operable for displaying said rendering information in response to said event identifier value matching said image identifier value in said control information, wherein said rendering information represents at least one image comprising differential image information for generating a composite image.

18. The system as recited in claim 17, wherein said graphical image information includes control information and corresponding rendering information representing a plurality of graphical images, wherein said processor further comprises:
circuitry operable for initially displaying a first graphical image of said plurality of graphical images.

19. The system as recited in claim 18, wherein said rendering information for said circuitry operable for displaying said rendering information comprises rendering information representing a second graphical image of said plurality of graphical images and wherein said first and second graphical images generating a composite image.

20. The system as recited in claim 19, wherein said first and second graphical images respectively represent first and second states of a control element in one or more web pages.

21. A system, comprising:
a memory unit operable for storing a computer program operable for associating graphical images displayed on a web page with client side events; and
a processor coupled to said memory unit, wherein said processor, responsive to said computer program, comprises:
circuitry operable for receiving a value for an event parameter associated with a graphical image file;
circuitry operable for receiving an event corresponding to said event parameter; and
circuitry operable for displaying rendering information for a graphical image in said graphical image file corresponding to said value of said event parameter in response to said event in said receiving step and wherein said rendering information comprises differential image information, wherein said processor further comprises:
circuitry operable for initially displaying a first graphical image of said plurality of graphical images, wherein said circuitry operable for displaying comprises displaying rendering information representing a second graphical image of said plurality of graphical images, said first and second graphical images generating a composite image.

22. The system as recited in claim 21, wherein said event in said circuitry operable for receiving is received from an event handler for a type of said event.

23. The system as recited in claim 21, wherein said graphical image file comprises a plurality of graphical images, wherein said circuitry operable for displaying rendering information comprises:
circuitry operable for sequentially bypassing a set of graphical images in said plurality of graphical images while a count value does not equal said event parameter value, wherein if said count value equals said event parameter value then said processor further comprises:
circuitry operable for displaying rendering information of a current graphical image in sequence in said plurality of graphical images.

24. The system as recited in claim 23, wherein said processor further comprises:
circuitry operable for initializing said count value; and
circuitry operable for incrementing said count value for each sequential bypass of said set of graphical.

25. A method comprising the steps of:
providing graphical image information including control information and rendering information, said control information for controlling a display of said rendering information, wherein said control information comprises an image identifier value;
receiving an event identifier value in response to a client initiated action; and
displaying said rendering information in response to said event identifier value matching said image identifier value in said control information, wherein said rendering information includes at least one graphical image comprising differential image information for generating a composite image, said graphical image information including control information and corresponding rendering information representing a plurality of graphical images and wherein said method further comprises initially displaying a first graphical image of said plurality of graphical images, and wherein said rendering information in said displaying step comprises rendering information representing a second graphical image of said plurality of graphical images, said first and second graphical images generating said composite image.

26. A method comprising:
receiving a value for an event parameter associated with a graphical image file;
receiving an event corresponding to said event parameter; and
displaying rendering information for a graphical image in said graphical image file corresponding to said value of said event parameter in response to said event in said receiving step, wherein said rendering information comprises differential image information, wherein said graphical image file comprises a plurality of graphical images and wherein said method further comprises initially displaying a first graphical image of said plurality of graphical images, said displaying step comprising displaying rendering information representing a second graphical image of said plurality of graphical images and wherein said first and second graphical images generate a composite image.

27. A system, comprising:
a memory unit operable for storing a computer program operable for generating pages; and
a processor coupled to said memory unit, wherein said processor, responsive to said computer program, comprises:
circuitry operable for generating said page for transmission to a client via a network, said page including a graphical control element, said graphical control element being responsive to user input, wherein said graphical control element comprises graphical image information, said graphical image information including control extension information and rendering information, said control extension information for controlling a display of said rendering information;
wherein said control extension information includes an image identifier value, said image identifier value for associating said user input with a display of rendering information; and
wherein said rendering information includes at least one graphical image comprising differential image information for generating a composite image representing a selected state of said control element.

28. The system of claim 27 wherein said graphical image information includes control extension information and rendering information representing a plurality of graphical images, and wherein at leas a first one and a second one of said plurality of graphical images generate said composite image.

29. The system of claim 28 wherein said rendering information further includes rendering information for representing said graphical control element in an initial state.

30. A computer program product embodied in a tangible, machine readable medium, including a data structure, said data structure comprising:
a plurality of graphical images, each of said plurality of graphical images including rendering information, and control information associated with said rendering information for controlling a display of said rendering information, said control information including an image identifier value;
wherein said image identifier value is operable for associating user input with a display of corresponding rendering information; and
wherein said rendering information includes at least one graphical image representing differential image information for generating a composite image.

31. The program product of claim 30 wherein said composite image is operable for generation in response to said user input.

32. The program product of claim 30 wherein said control information further includes a disposal value operable for controlling a disposal method of displayed rendering information.
